(19) United States
(12) Patent Application Publication
(10) Pub. No.: US 2022/0385457 A1
(43) Pub. Date: Dec. 1, 2022

(54) ORIGINAL CERTIFICATION METHOD, AND USER TERMINAL AND KEY MANAGEMENT SERVER FOR THE SAME

(71) Applicant: SAMSUNG SDS CO., LTD., Seoul (KR)

(72) Inventors: Eun Kyung KIM, Seoul (KR); Kwan Sik YOON, Seoul (KR)

(21) Appl. No.: 17/825,675

(22) Filed: May 26, 2022

(30) Foreign Application Priority Data
May 28, 2021 (KR) 10-2021-0069416

(51) Int. Cl. H04L 9/08; H04L 9/32

(52) U.S. Cl. CPC H04L 9/0825; H04L 9/3247; H04L 9/3263

(57) ABSTRACT

An original certification method according to an embodiment of the present disclosure includes obtaining target data, obtaining a plurality of partial signatures associated with the target data, generating a signature of the target data based on the plurality of partial signatures, and transmitting the target data and the signature to an external device. The plurality of partial signatures are respectively generated based on different private keys among a plurality of private keys, a first private key among the plurality of private keys is stored in a first device, a second private key among the plurality of private keys is stored in a second device, and the first device and the second device are physically separated from each other.

### CROSS-REFERENCE TO RELATED APPLICATION

This application claims priority from Korean Patent Application No. 10-2021-0069416 filed on May 28, 2021 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to an original certification method, and a user terminal and a key management server for the same, and more particularly, to an original certification method for certifying whether multimedia data is original data or processed data, and a user terminal and a key management server for the same.

### 2. Description of the Related Art

With the development of digital image processing technology and image printing technology, the demand for verifying whether multimedia data such as an image or a certificate file is an original is increasing. This is because it is not easy to determine the authenticity of multimedia data processed by sophisticated technology with the human eye.

Conventional multimedia data forgery/falsification detection technology detects whether an original is forged/falsified by using a watermark or digital signature with an already generated multimedia product file, or checks that the file is an original by analyzing the characteristics of the file itself. Among them, since the method using the digital signature assumes that a private key used for signature is safely managed, a reliability of the forgery/falsification detection result may not be guaranteed when the private key is hacked or leaked. In addition, in the case of performing original certification on a plurality of institutions, it may be necessary to use a different private key for each institution. Therefore, it may be difficult to efficiently manage each private key when there are a large number of certification target institutions.

Meanwhile, when the contents contained in a data file are processed even if the data file itself is not forged/falsified, it may be difficult to certify the original by just detecting the forgery/falsification of the data file. For example, in the case of creating a data file by creating a processed image using a computer, printing the image, and then photographing the output image, even if no manipulation has been applied to the data file itself, the data file may not be certified as the original by itself because the subject is an imaginary subject at the start.

Therefore, there is a demand for a new method of original certification technology that may more safely and efficiently manage the private key, and sometimes even determine the authenticity of the contents contained in the data file.

### SUMMARY

Technical aspects to be achieved through one embodiment by the present disclosure provide an original certification method capable of more safely managing a private key for digital signature, and a user terminal and a key management server for the same.

Technical aspects to be achieved through other embodiments by the present disclosure also provide an original certification method capable of efficiently managing a private key for each certification target institution, and a user terminal and a key management server for the same.

Technical aspects to be achieved through still other embodiments by the present disclosure also provide an original certification method capable of verifying whether the content contained in a data file is original or processed, and a user terminal and a key management server for the same.

However, the technical aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the inventive concept, there is a provided method for certificating original, which includes obtaining target data, obtaining a plurality of partial signatures associated with the target data, generating a signature of the target data based on the plurality of partial signatures, and transmitting the target data and the signature to an external device, wherein the plurality of partial signatures are respectively generated based on different private keys among a plurality of private keys, a first private key among the plurality of private keys is stored in a first device, a second private key among the plurality of private keys is stored in a second device, and the first device and the second device are physically separated from each other.

In some embodiments, the first device may be a user terminal, and the second device may be another terminal registered with a key management server.

In some embodiments, the first device may be a user terminal, and the second device may be a service server accessible through an account registered with a key management server.

In some embodiments, the obtaining of the target data may include generating hash data for at least a portion of the target data.

In some embodiments, a first partial signature among the plurality of partial signatures may be a signature value generated based on the first private key and the hash data, and a second partial signature among the plurality of partial signatures may be a signature value generated based on the second private key and the hash data.

In some embodiments, the second partial signature may be generated in the second device, and the obtaining of the plurality of partial signatures may include receiving the second partial signature.

In some embodiments, the generating of the signature of the target data, the signature may be generated based on a combination of the plurality of partial signatures.

In some embodiments, the original certification method may further include generating the plurality of private keys and a plurality of public keys corresponding to each of the plurality of private keys.

In some embodiments, the plurality of private keys may be distributed and stored in a plurality of devices including the first device and the second device, and the plurality of public keys may be transmitted to a key management server.

In some embodiments, the external device may verify the target data or the signature using a verification key, and the verification key may be generated based on a plurality of public keys corresponding to each of the plurality of private keys.

In some embodiments, the verification key may be provided from a key management server to the external device in response to a request from the external device.

In some embodiments, the obtaining of the target data may include generating an image by photographing a subject by a photographing method based on a real subject discrimination algorithm.

In some embodiments, the generating of the image may include obtaining a screen division value, classifying a photographing screen into a plurality of sections based on the screen division value, photographing a first image by focusing on a first section among the plurality of sections, photographing a second image by focusing on a second section among the plurality of sections, and storing the first image and the second image as the image.

According to another aspect of the inventive concept, there is a provided a method for certificating original, which includes extracting a plurality of public keys from a plurality of key management information in response to a verification key provision request from a service requesting device, generating a verification key based on the plurality of public keys; and transmitting the verification key to the service requesting device, wherein the plurality of key management information correspond to a plurality of terminals or a plurality of accounts, respectively, the plurality of public keys correspond to a plurality of private keys distributed and stored in the plurality of terminals or the plurality of accounts, respectively, and the verification key is used to verify a signature generated based on the plurality of private keys.

In some embodiments, the original certification method may further include updating the plurality of key management information in response to a request from a user terminal.

In some embodiments, the original certification method may further include discriminating whether a target image is an image obtained by photographing a real subject in response to a real subject verification request from the service requesting device.

In some embodiments, the target image may include a first image and a second image, the first image and the second image may be images obtained by photographing the same subject, and the discriminating may include obtaining a screen division value related to the image, checking focused sections of the first image and the second image with reference to the screen division value, and discriminating whether the image is an image obtained by photographing a real subject based on a result of checking the focused sections.

According to still another aspect of the inventive concept, there is a provided computing device, which includes a processor and a memory into which a computer program is loaded, wherein the computer program may include an instruction for obtaining target data, an instruction for obtaining a plurality of partial signatures associated with the target data, an instruction for generating a signature of the target data based on the plurality of partial signatures, and an instruction for transmitting the target data and the signature to an external device, the plurality of partial signatures may be respectively generated based on different private keys among a plurality of private keys, a first private key among the plurality of private keys is stored in a first device, and a second private key among the plurality of private keys is stored in a second device.

In some embodiments, the computer program may further include an instruction for generating the plurality of private keys and a plurality of public keys corresponding to each of the plurality of private keys.

In some embodiments, the plurality of private keys may be distributed and stored in a plurality of devices including the first device and the second device, and the plurality of public keys may be transmitted to a key management server.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic diagram for describing an original certification method according to exemplary embodiments of the present disclosure;

FIG. 2 is a flowchart for describing an original certification method according to an exemplary embodiment of the present disclosure;

FIG. 3 is a diagram for further describing step S110 of FIG. 2;

FIG. 4 is a flowchart for specifically describing step S120 of FIG. 2;

FIG. 5 is a flowchart illustrating an example of step S121 of FIG. 4;

FIG. 6 is a flowchart for specifically describing step S130 of FIG. 2;

FIG. 7 is a flowchart for describing an original certification method according to another exemplary embodiment of the present disclosure;

FIG. 8 is a flowchart for describing an original certification method according to still another exemplary embodiment of the present disclosure;

FIGS. 9 and 10 are diagrams for further describing step S310 of FIG. 8;

FIG. 11 is a flowchart for describing an original certification method according to still another exemplary embodiment of the present disclosure;

FIG. 12 is a diagram for conceptually describing a method for photographing and discriminating an image based on a real subject discrimination algorithm of the present disclosure;

FIG. 13 is a block diagram illustrating a detailed method of photographing a multi-focus image through a photographing device and a discriminating device illustrated in FIG. 12 and discriminating whether the image is a real image based thereon;

FIG. 14 is a diagram for specifically describing the multi-focus image mentioned in FIG. 13 and a photographing method thereof;

FIG. 15 is a diagram for specifically describing examples of screen classification according to various screen division values;

FIG. 16 is a diagram for specifically describing examples of setting a photographing order according to various order values;

FIG. 17 is a diagram for describing an exemplary embodiment in which the method of photographing an image according to the present disclosure is applied in units of pixels;

FIG. 18 is a flowchart illustrating a method of photographing an image according to an exemplary embodiment of the present disclosure;

FIG. 19 is a flowchart illustrating a method of discriminating an image according to an exemplary embodiment of the present disclosure;

FIG. 20 is a flowchart illustrating an exemplary embodiment in which a step of discriminating a type of an image of FIG. 19 is described in more detail; and

FIG. 21 is a block diagram illustrating an exemplary hardware configuration of a computing device 500 in which various exemplary embodiments of the present disclosure are implemented.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings:

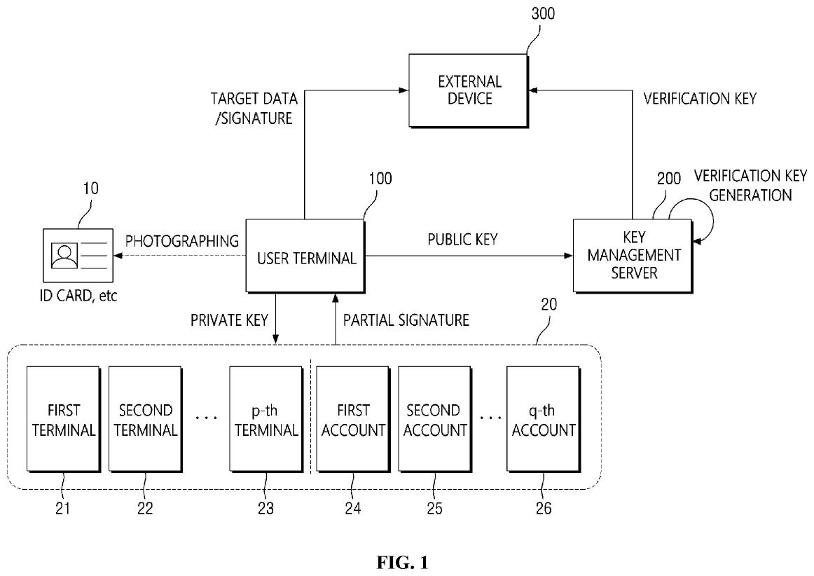

FIG. 1 is a schematic diagram for describing an original certification method according to exemplary embodiments of the present disclosure. Referring to FIG. 1, an original certification method may be performed between a user terminal 100, a key management server 200, or an external device 300.

The user terminal 100 generates a plurality of pairs of a private key and a public key to be used in the original certification method. For example, the user terminal 100 may generate a first encryption key pair, for example, a first private key and a first public key using a key generation algorithm, generate a second private key and a second public key using the key generation algorithm again, and generate an arbitrary number of a plurality of private and public keys by repeating such a process.

The user terminal 100 distributes and stores the plurality of generated private keys in a plurality of key storage means 20. The plurality of key storage means 20 may include a plurality of terminals 21, 22, and 23 or a plurality of accounts 24, 25, and 26 of a user capable of communicating with the user terminal 100 directly or via a key management server 200. The user terminal 100 distributes and stores each private key in the plurality of terminals 21, 22, and 23 or the plurality of accounts 24, 25, and 26 so that the plurality of generated private keys are not concentrated in any one place. Here, storing the private key in the user's accounts 24, 25, and 26 may mean storing the private key in an external service server accessible through the user's accounts 24, 25, and 26. For example, when a first account 24 is a user's KakaoTalk account, storing the private key in the first account 24 may mean storing the private key in a KakaoTalk service server accessible through the user's KakaoTalk account. The respective devices 21, 22, 23, 24, 25, and 26 included in the plurality of key storage means 20 may be devices physically separated from each other.

As an example, the user terminal 100 may store any one of the plurality of generated private keys in the user terminal 100, and distribute and store the remaining private keys in the plurality of key storage means 20.

Meanwhile, the plurality of public keys generated together with the private keys are transmitted to the key management server 200. The key management server 200 stores the plurality of transmitted public keys in its own storage.

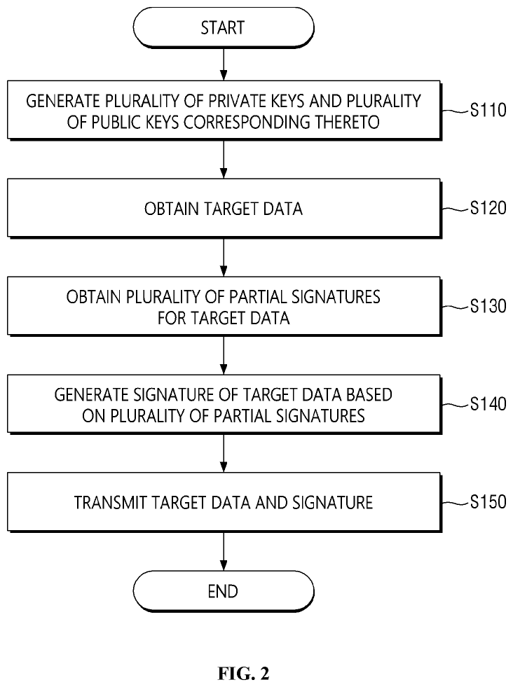

The user terminal 100 generates target data to be provided to the external device 300. The target data may be multimedia data including an image obtained by photographing a subject 10. After the target data is generated, the user terminal 100 generates a signature for certifying an original of the target data. In this case, the user terminal 100 may receive a plurality of partial signatures associated with the target data from the plurality of key storage means 20, and may generate a signature of the target data based on a combination of the plurality of partial signatures. The user terminal 100 transmits the generated target data and the signature of the target data to the external device. A specific method of generating the target data and the signature of the target data will be described in more detail below with reference to FIG. 2.

The external device 300 receives the target data and the signature from the user terminal 100. In addition, the external device 300 requests a verification key from the key management server 200 to verify an original of the target data. As an example, the external device 300 may be a server of an external institution, such as a government office or an insurance company, to which the user needs to submit the target data as certification data.

The key management server 200 generates a verification key in response to the request from the external device 300 and provides the generated verification key to the external device. In this case, the key management server 200 may extract public keys necessary for generating the verification key among the plurality of public keys previously received from the user terminal 100, and generate the verification key based on a combination of the extracted public keys.

As an example, the key management server 200 may generate the verification key to correspond to the signature provided by the user terminal 100 to the external device 300. For example, when the signature is generated based on a first private key and a second private key among the distributed and stored private keys, the key management server 200 may extract a first public key and a second public key among the plurality of public keys, and generate the verification key based on the extracted first and second public keys. For example, when the signature is generated based on the first private key, a third private key, and a fourth private key among the distributed and stored private keys, the key management server 200 may extract the first public key, the third private key, and the fourth public key among the plurality of public keys, and generate the verification key based on the extracted first, third, and fourth public keys. Here, it is assumed that each of the first private key and the first public key, the second private key and the second public key, the third private key and the third public key, and the fourth private key and the fourth public key is a pair of encryption keys corresponding to each other.

When the key management server 200 provides the verification key to the external device 300, the external device 300 verifies a validity of the signature transmitted by the user terminal 100 using the provided verification key. For example, the external device 300 may input the signature, the verification key, and the target data as input parameters to a verification algorithm as expressed in Equation 1 below, and verify the validity of the signature through a result value calculated from Equation 1.

Verify(pk, m, s)→result value: 0 or 1 [Equation 1]

Here, Verify( ) is a verification algorithm or verification function, pk is a verification key, m is target data, and s is a signature. In this case, hash data of the target data may also be input to the verification algorithm instead of the target data.

If the result value calculated from Equation 1 is 1, it may be determined that the signature is valid and the original certification of the target data has been successful. On the other hand, if the result calculated from Equation 1 is 0, it may be determined that the signature is invalid and the original certification of the target data has also failed. However, this is merely an example and the scope of the present disclosure is not limited thereto. For example, complementary to the above-described example, if the result value calculated from Equation 1 is 0, it may be determined that the signature is valid, and if the result value calculated from Equation 1 is 1, it may be determined that the signature is invalid.

According to the exemplary embodiment of FIG. 1 described above, the plurality of private keys for verifying the digital signature are distributed and stored in the user terminal 100 and the plurality of key storage means 20. Accordingly, even if the private key stored in any one device is leaked to the outside, the private keys stored in the other devices may be safely stored, and since it is impossible to forge the signature with only one leaked private key, a security of the private key may be maintained as a whole.

FIG. 2 is a flowchart for describing an original certification method according to an exemplary embodiment of the present disclosure. In FIG. 2, the original certification method described in FIG. 1 will be described in more detail from the viewpoint of the user terminal 100. Accordingly, when a performing subject is omitted in each step of FIG. 2, it is assumed that the performing subject is the user terminal 100 of FIG. 1. Meanwhile, in the description of FIG. 2, the content overlapping the previously described content is omitted for the sake of brevity of the description.

In step S110, a plurality of private keys and a plurality of public keys corresponding thereto are generated. In this case, a pair of each private key and a public key corresponding thereto may be generated using a key generation algorithm as expressed in Equation 2.

KeyGen()→result value: ski, pki [Equation 2]

Here, KeyGen( ) is a key generation algorithm that generates a pair of encryption keys, a is a random number or a random value input as an input parameter to the key generation algorithm, ski is an i-th private key, pki is an i-th public key, and ski and pki are a pair of encryption keys corresponding to each other.

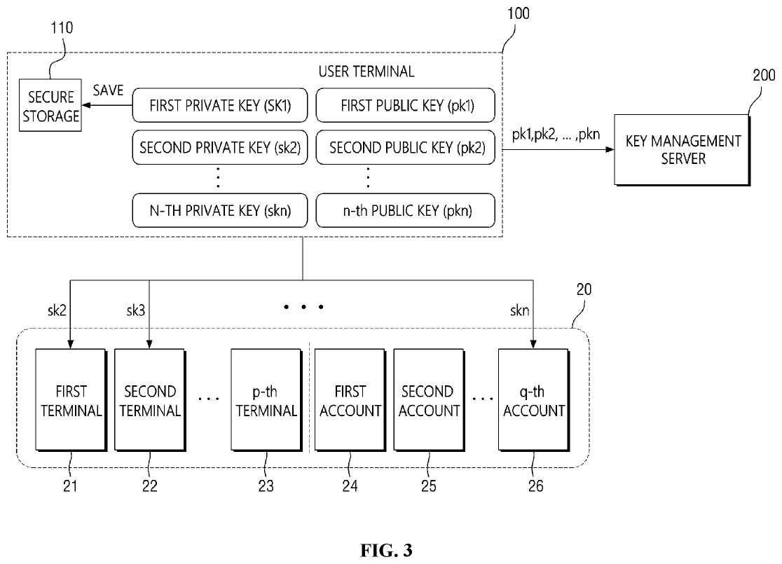

If the key generation algorithm is repeatedly performed, a desired number of pairs of a plurality of private and public keys may be generated. The plurality of generated private keys are distributed and stored in the user terminal and the plurality of key storage means, and the plurality of generated public keys are stored in the key management server. This will be further described with reference to FIG. 3.

In FIG. 3, the user terminal 100 generates a plurality pairs of encryption keys through the key generation algorithm as in Equation 2 above. For example, the user terminal 100 may generate a first private key sk1 and a first public key pk1 by performing a first key generation algorithm, generate a second private key sk2 and a second public key pk2 by performing a second key generation algorithm, and generate an n-th private key skn and an n-th public key pkn by similarly performing an n-th key generation algorithm.

The first private key sk1 among the plurality of generated private keys is stored in a secure storage 110 of the user terminal 100. The remaining private keys sk2, sk3, . . . , skn among the plurality of generated private keys are distributed and stored in the plurality of key storage means 20. Specifically, the second private key sk2 is stored in the first terminal 21, the second private key sk3 is stored in the second terminal 22, the remaining private keys are sequentially stored in other terminals 23 or accounts 24 and 25, and the n-th private key skn may be then stored in a q-th account 26. However, this is merely a specific example for convenience of description, and the scope of the present disclosure is not limited thereto. For example, the remaining private keys sk2, sk3, . . . , skn may be distributed and stored only in the terminals 21, 22, and 23 among the plurality of key storage means 20, or the remaining private keys sk2, sk3, . . . , skn may be distributed and stored only in the accounts 24, 25, and 26 among the plurality of key storage means 20.

Meanwhile, the plurality of generated public keys pk1, pk2, . . . , pkn are transmitted to the key management server 200 and stored in the key management server 200.

Returning to FIG. 2 again, in step S120, target data is obtained. Here, the target data is data for which original certification is to be performed on the external device, and may be multimedia data including documents, images, moving pictures, or audio.

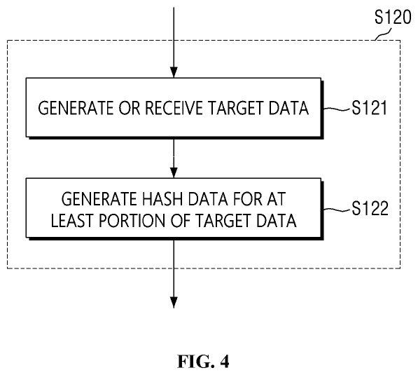

As an example, after the target data is obtained, hash data for at least a portion of the target data may be further generated. When the target data is directly input to a signature generation algorithm, a message length of the target data input as an input parameter to the signature generation algorithm may vary for each target data. On the other hand, when the hash data of the target data is obtained and is then input to the signature generation algorithm, it is possible to provide an input parameter of a constant length to the signature generation algorithm because the hash data has a fixed length. This will be further described with reference to FIG. 4.

FIG. 4 is a flowchart for specifically describing step S120 of FIG. 2.

In step S121, the target data is generated or received. For example, the target data may be directly generated in the user terminal by a method of photographing a subject using a camera of the user terminal. Alternatively, the target data may also be received by the user terminal by being externally generated and then transmitted to the user terminal through a wired or wireless network.

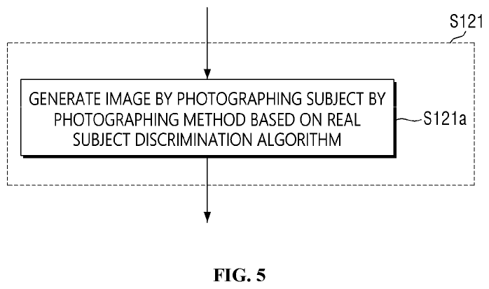

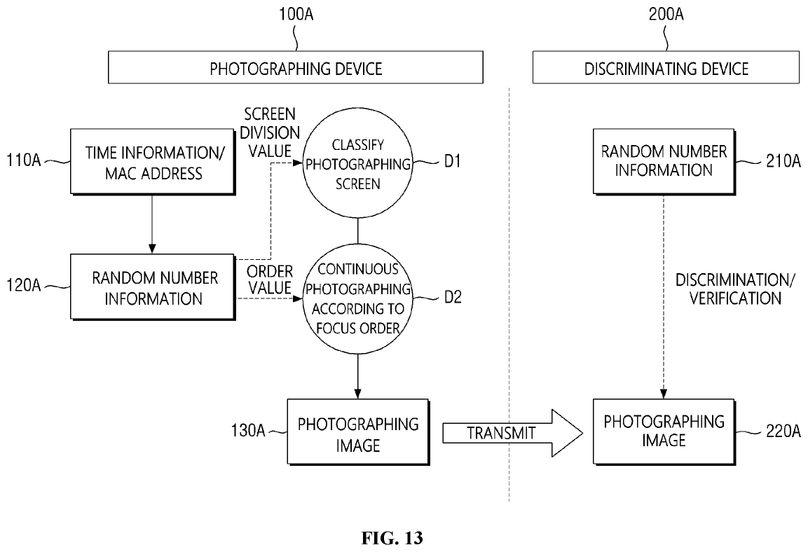

As an example, when the target data is generated in the user terminal, the user terminal may generate the target data by a method of photographing a subject by a photographing method based on a real subject discrimination algorithm as in the embodiment of FIG. 5. This is to verify whether the image contained in the target data is an image obtained by photographing a real subject or a processed image obtained by re-photographing an existing photographed image as a subject. When an image is photographed with the photographing method based on the real subject discrimination algorithm proposed in the present disclosure, it is possible to discriminate whether the image is an image obtained by photographing the real subject or an image obtained by photographing an imaginary subject through a discrimination method corresponding thereto. The real subject algorithm proposed by the present disclosure and the image photographing method and reading method according thereto will be described in detail below with reference to FIG. 13, and thus a description thereof will be omitted.

In step S122, hash data for at least a portion of the target data is generated. For example, the hash data of the target data may be generated by inputting all of the target data into a hash function or inputting only meta data of the target data into the hash function. The generated hash data may have a fixed size of length regardless of a size of the input target data.

Returning again to FIG. 2, in step S130, a plurality of partial signatures associated with the target data are obtained. In this case, each of the plurality of partial signatures may be a value obtained by inputting one of the plurality of private keys and the target data to the signature generation algorithm. Alternatively, each of the plurality of partial signatures may be a value obtained by inputting one of the plurality of private keys and the hash data of the target data to the signature generation algorithm. In this case, the hash data is data of a fixed size obtained by inputting at least a portion of the target data into the hash function as described above.

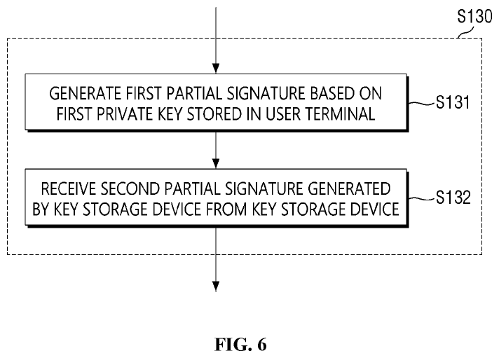

As an example, the plurality of partial signatures may be respectively generated based on different private keys among the plurality of private keys. This will be further described with reference to FIG. 6.

FIG. 6 is a flowchart for specifically describing step S130 of FIG. 2. Similarly to the above-described exemplary embodiments, it is also assumed in the present embodiment that the plurality of private keys generated by the user terminal are distributed and stored in the user terminal and the plurality of key storage means.

In step S131, a first partial signature associated with the target data is generated based on the first private key stored in the user terminal. In this case, the first partial signature may be generated using the signature generation algorithm as expressed in Equation 3.

Sign(ski, m)→result value: si [Equation 3]

Here, Sign( ) is a signature generation algorithm that generates a partial signature using a private key, ski is an i-th private key, m is the target data, and si is an i-th partial signature associated with the target data. In this case, hash data of the target data may be input to the signature generation algorithm instead of the target data.

For other private keys, partial signatures are generated in a similar manner. Specifically, the first terminal in which the second private key is stored generates a second partial signature by using the second private key as an input parameter of the signature generation algorithm, and the second terminal in which the third private key is stored generates a third partial signature by using the third private key as an input parameter of the signature generation algorithm. In this way, partial signatures corresponding to each of the private keys are generated in the terminals or the accounts in which the private keys are stored. In this case, the partial signature being generated in the account may mean that the partial signature is generated in an external service server accessible through the account.

In step S132, the partial signatures generated in the key storage means are transmitted to the user terminal. Since the user terminal has the first partial signature, the user terminal receives the remaining partial signatures from the key storage means except for the first partial signature. Specifically, in such a way that the second partial signature is received from the first terminal of the key storage means and the third partial signature is received from the second terminal of the key storage means, each of the partial signatures is received from the terminals or accounts of the key storage means. In this case, the partial signature being received from the account may mean that the partial signature is received from the external service server accessible through the account.

Through the above-described process, each of the partial signatures s1, s2, . . . , sn corresponding to each of the generated private keys sk1, sk2, . . . , skn is collected in the user terminal.

Returning again to FIG. 2, in step S140, a signature of the target data is generated based on the plurality of obtained partial signatures. In this case, the signature may be generated using a signature aggregate algorithm as expressed in Equation 4.

SigAggregate(s1, s2, . . . sn)→result value: s [Equation 4]

Here, SigAggregate( ) is an algorithm that generates a single signature based on the plurality of partial signatures, si is an i-th partial signature, and s is a signature obtained as a result value.

As an example, an algorithm of Equation 5 below may be used instead of Equation 4 as the signature aggregate algorithm.

SigAggregate(pk1, pk2, . . . , pkn, s1, s2 . . . , sn)→result value:s [Equation 5]

Here, SigAggregate( ) is an algorithm that generates a single signature based on the plurality of partial signatures, pki is an i-th public key, si is an i-th partial signature, and s is a signature obtained as a result value.

That is, the previously generated public keys as input parameters of the signature aggregate algorithm may be additionally input together with the partial signatures.

In step S150, the target data and the signature are transmitted to the external device. The transmitted signature is verified with a verification key in the external device, and when the verification is successfully completed, it is considered that the original certification of the target data has been performed.

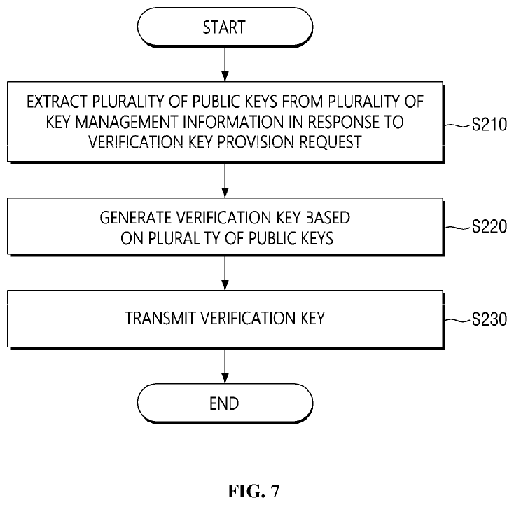

FIG. 7 is a flowchart for describing an original certification method according to another exemplary embodiment of the present disclosure. In FIG. 7, a method for the key management server to generate and provide a verification key for original certification is described. Accordingly, when a performing subject is omitted in the following steps, it is assumed that the performing subject is the key management server 200 of FIG. 1.

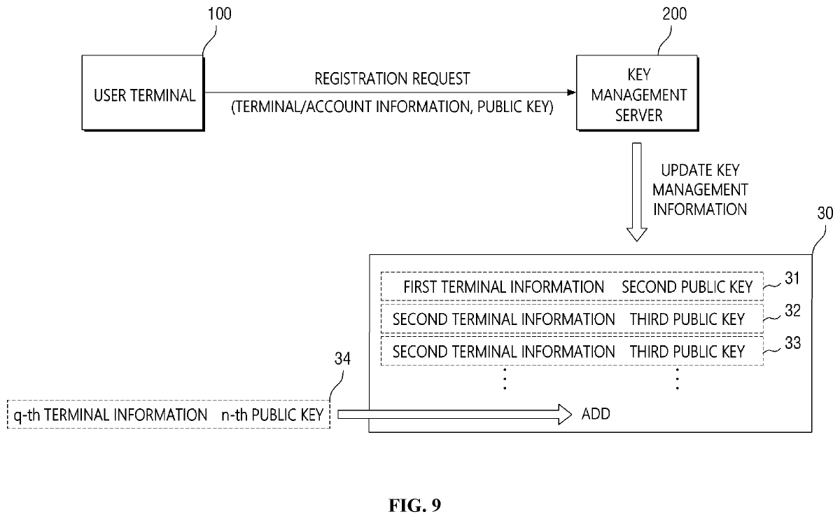

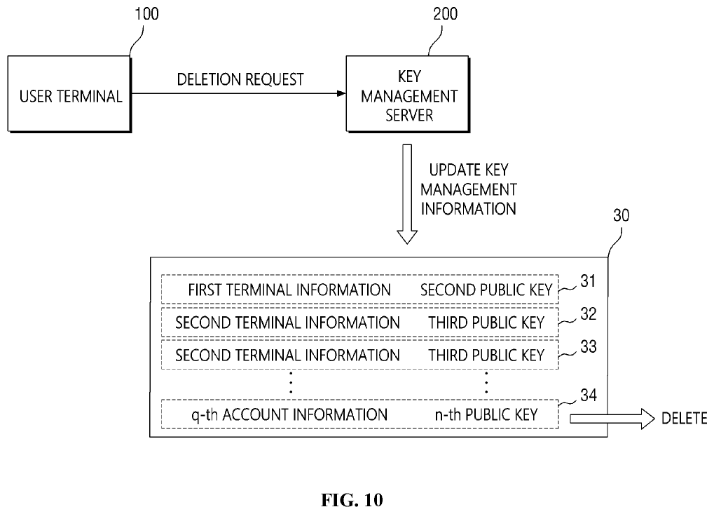

In step S210, when a verification key provision request is received from the external device, the key management server extracts a plurality of public keys necessary for generating a verification key from a plurality of key management information in response the verification key provision request. Here, the key management information is information in which the public key received from the user terminal is stored together with terminal information or account information corresponding thereto, and a specific form thereof will be described later in detail with reference to FIGS. 9 and 10.

As an example, when the plurality of public keys are extracted from the plurality of key management information, public keys corresponding to the signature generated by the user terminal may be selectively extracted. For example, when the user terminal generates a partial signature based on a first private key, a third private key, and a seventh private key and generates a signature from the partial signature, a first public key, a third public key, and a seventh public key that are paired with the first private key, the third private key, and the seventh private key may be extracted from the plurality of key management information.

In step S220, a verification key is generated based on the plurality of extracted public keys. In this case, the verification key may be generated using a public verification key aggregate algorithm as expressed in Equation 6.

KeyAggregate(pk1, pk2, . . . , pkn)→result value: pk [Equation 6]

Here, KeyAggregate( ) is an algorithm that generates a single verification key based on the plurality of public keys, pki is an i-th public key, and pk is a verification key obtained as a result value.

In step S230, the verification key is transmitted from the key management server to the external device. The external device verifies the signature transmitted by the user terminal using the transmitted verification key.

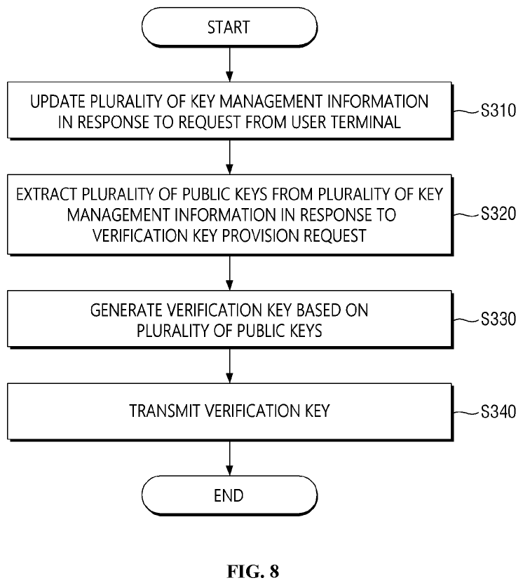

FIG. 8 is a flowchart for describing an original certification method according to still another exemplary embodiment of the present disclosure. An exemplary embodiment of FIG. 8 is mostly similar to the exemplary embodiment of FIG. 7. However, it is different in that step S310 is added. Steps S320, S330, and S340 of FIG. 8 are substantially the same as steps S210, S220, and S230 of FIG. 7, respectively. Accordingly, in order to avoid duplication of description, the description of steps S320 to S340 is omitted here.

In step S310, the key management information stored in the key management server is updated in response to the request of the user terminal. For example, when there is a request for adding a public key from the user terminal, the corresponding public key is added to the key management information together with associated terminal or account information. Alternatively, when there is a request for deleting the public key from the user terminal, the corresponding public key and the terminal or account information associated therewith are deleted from the key management information. Here, the associated terminal or account information means information on a terminal or account in which a private key paired with the public key is stored.

This will be further described with reference to FIGS. 9 and 10.

FIG. 9 illustrates an exemplary embodiment in which a new public key is added to the key management information. First, the user terminal 100 requests registration of a new public key. In this case, the public key and the terminal or account information associated with the public key are transmitted from the user terminal 100. The key management server 200 adds the requested public key and the associated terminal or account information to its own key management information 30 in response to the request of the user terminal 100. Referring to FIG. 9, an example in which n-th public key information 34 is added to existing information 31, 32, and 33 of the key management information 30 is illustrated.

FIG. 10 illustrates an exemplary embodiment in which some public keys are deleted from the key management information. First, the user terminal 100 requests deletion of an n-th public key. In this case, information on the public key to be deleted is transmitted from the user terminal 100. The key management server 200 deletes the requested public key and the associated terminal or account information from its own key management information 30 in response to the request of the user terminal 100. Referring to FIG. 10, an example in which the n-th public key information 34 is deleted from the existing information 31, 32, and 33 of the key management information 30 is illustrated.

According to the exemplary embodiments, each public key may be more efficiently managed. For example, when a user adds a new terminal or account for distributed storage of the private key, or wants to delete a previously registered terminal or account, the corresponding public key and associated information may be added to or deleted from the key management server by the method of the present exemplary embodiment. Accordingly, it is possible to manage a combination of the public keys required for automatically generating the public key and the verification key through the key management server without separately managing the public key and associated terminal or account information in the user terminal.

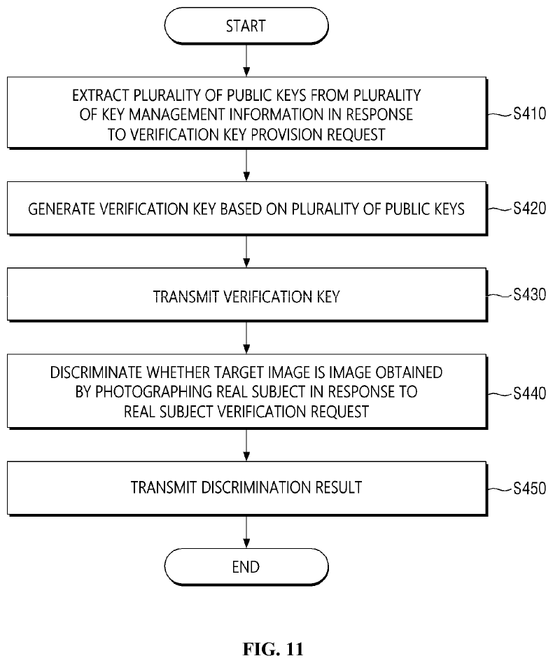

FIG. 11 is a flowchart for describing an original certification method according to still another exemplary embodiment of the present disclosure. An exemplary embodiment of FIG. 11 is mostly similar to the exemplary embodiment of FIG. 7. However, it is different in that steps S440 and S450 are added to discriminate whether a target image included in the target data is an image obtained by photographing a real subject. Steps S410, S420, and S430 of FIG. 11 are substantially the same as steps S210, S220, and S230 of FIG. 7, respectively. Accordingly, in order to avoid duplication of description, the description of steps S410 to S430 is omitted here.

In step S440, when a verification request for a real subject is received from the external device, it is discriminated whether the target image included in the target data is an image obtained by photographing the real subject in response to the verification request.

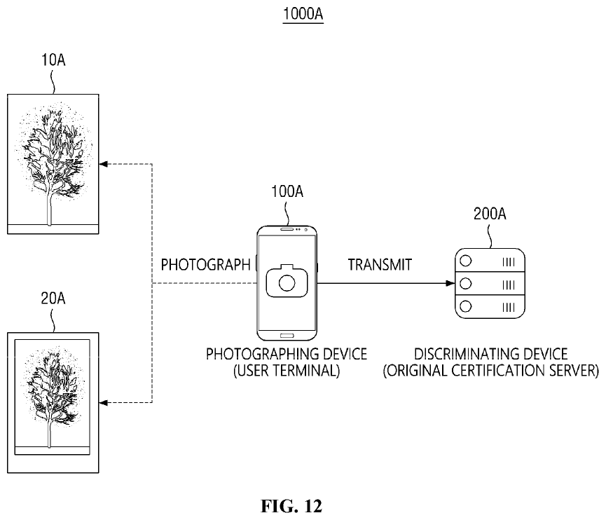

In the case in which the photographing method based on the real subject discrimination algorithm is used when generating the image through the camera in FIG. 5 above, this is to discriminate whether the corresponding image is a real subject image through a corresponding discrimination method. Since the specific content of the discrimination method will be described later in detail in FIG. 12 and subsequent drawings, a description thereof will be omitted herein.

In step S450, the discrimination result is transmitted to the external device. The external device may determine whether the target data transmitted by the user terminal is an original image or a processed image with reference to the transmitted discrimination result.

In FIG. 12 and subsequent drawings, a detailed description of the real subject discrimination algorithm referenced in the previous descriptions is provided. Hereinafter, the related description will be continued with reference to the drawings.

Image Photographing Method and Discrimination Method Based on Real Subject Discrimination Algorithm

In the present section, there is described a method for verifying whether the content contained in a data file is original, particularly, a real subject discrimination algorithm for discriminating whether an image of multimedia data is an image obtained by photographing a real subject or an image obtained by re-photographing an existing photographed image as the subject, and an image photographing method and an image discrimination method based on the algorithm.

FIG. 12 is a diagram for conceptually describing a method for photographing and discriminating an image based on a real subject discrimination algorithm of the present disclosure.

In a system environment 1000A illustrated in FIG. 12, a photographing device 100A (e.g., a user terminal) photographs subjects 10A and 20A using a built-in camera.

The subjects 10A and 20A to be photographed may be a real subject 10A that actually exists, or may be a picture or a video screen 20A that has been photographed. Hereinafter, the real subject, which is an object that actually exists, is referred to as a three-dimensional subject, and the subject, which is the picture or the video screen that has been photographed is referred to as a two-dimensional subject.

In this case, the photographing device 100A photographs a plurality of images with different focus points for the same subject in order to discriminate whether the photographed image is a three-dimensional subject image or a two-dimensional subject image. The plurality of images photographed in this way will be referred to as a multi-focus image. Since the specific contents of the multi-focus image and the photographing method thereof will be described later in detail, a detailed description thereof is omitted herein.

In addition, after storing the multi-focus image, the photographing device 100A transmits the multi-focus image to a discriminating device 200A at a synchronization point with the discriminating device 200A (e.g., a key management server).

The discriminating device 200A analyzes the target image, that is, the previously transmitted multi-focus image to discriminate a type of the corresponding image whether the image is the three-dimensional subject image or the two-dimensional subject image. For example, when the previously photographed subject is the three-dimensional subject 10A, an image in which different portions are focused will be photographed whenever a focus point is changed. For example, when the focus point is a background, an image is photographed with a clear background but a blurred tree, and when the focus point is a tree, an image is photographed with a clear tree but a blurred background. On the other hand, when the previously photographed subject is the two-dimensional subject 20A, an image with no significant difference in the focused portion will be photographed even if the focus point is changed. That is, in the case of the two-dimensional subject 20A, since a distance (or depth) from the photographing device 100A is the same regardless of whether the focus point is the background or the tree, an image in which both the background and the tree have the same sharpness (i.e., similar to the previously photographed photo or video screen) is photographed.

According to such a principle, the discriminating device 200A analyzes the multi-focus image, and discriminates the image as the three-dimensional subject image obtained by photographing the real subject 10 when the focused portions of the multi-focus image are different from each other. Conversely, the discriminating device 200A analyzes the multi-focus image, and discriminates the image as the two-dimensional subject image when the focused portions of the multi-focus image are the same or similar to each other.

As an example, in this case, the discriminating device 200A may discriminate the type of the multi-focus image by further referring to a focused area or a focused order of the focused portions. This will be described again in FIG. 13 and subsequent drawings.

According to the method of the present disclosure described above, it is possible to easily discriminate whether an image processed by re-photographing the previously photographed photo or video screen, and manipulating, forging, or falsifying the re-photographed photo or video screen as if a real object is photographed is submitted. When the focused portions of the multi-focus image are the same or similar to each other, it may be seen that the two-dimensional subject is photographed, and thus it may be known that an actual object is not photographed.

FIG. 13 is a block diagram illustrating a detailed method of photographing a multi-focus image through the photographing device 100A and the discriminating device 200A illustrated in FIG. 12 and discriminating whether the image is a real image based thereon. In an exemplary embodiment of FIG. 13, a method of dividing a screen to divide an area to be multi-focused and photographing and discriminating a multi-focus image in consideration of a focus order for the divided area is described. Hereinafter, a description will be provided with reference to the drawings.

First, the photographing device 100A generates random number information 120A according to a predetermined rule. As an example, the random number information 120A may be generated based on time information and an MAC address 110A of the photographing device 100A.

The photographing device 100A generates the random number information 120A by using a predetermined random number generation algorithm in order to share the random number information 120A with the discriminating device 200A. In this case, the random number generation algorithm may be an algorithm that receives time information when generating the random number information 120A and the MAC address of the photographing device 100A that generates the random number information 120A as input factors, so that different random number information is generated according to a time and the photographing device for photographing a multi-focus image. There are various types of random number generation algorithms for generating random numbers based on specific input factors, and the technical contents thereof are also widely known in the art, and thus a detailed description thereof will be omitted here.

The generated random number information 120A may include a screen division value referenced for dividing and classifying a photographing screen when multi-focus photographing is performed, and an order value designating a focus order of each divided and classified screen area.

The photographing device 100A classifies the photographing screen into a plurality of areas according to the screen division value among the random number information 120A (D1). For example, when the screen division value is 3, the photographing device 100A classifies the photographing screen into three areas. Similarly, when the screen division value is 9, the photographing device 100A classifies the photographing screen into nine areas. Thereafter, when the multi-focus photographing is performed, the photographing device 100A focuses the subject based on each of the classified areas.

Next, the photographing device 100A selectively focuses the classified areas according to the order value among the random number information 120A to continuously photograph the subject (D2). For example, when it is assumed that there are three areas divided by the screen division value, and an order value is assigned as a vector value of [3, 2, 1] to the divided areas, the same subject is repeatedly and continuously photographed according to the order value in such a way that at first, the subject is photographed by focusing on a third area to which the order value ‘1’ is assigned among the divided areas, next, the same subject is repeatedly photographed by focusing on a second area to which the order value ‘2’ is assigned among the divided areas, and finally, the same subject is repeatedly photographed by focusing on a first area to which the order value ‘3’ is assigned among the divided areas.

In addition, the photographing device 100A stores a plurality of images generated through such multi-focus photographing as a multi-focus image 130A. In the example described above, since three continuous photographing have occurred by changing the focus point according to the order value [3, 2, 1], the multi-focus image 130A includes a total of three images.

Meanwhile, here, it has been exemplified that the multi-focus photographing is performed once for each classified area, but the scope of the present disclosure is not limited thereto. For example, when it is assumed that there are 9 areas classified by the screen division value, and an order value is assigned as a vector value of [3, 0, 0, 2, 0, 0, 1, 0, 0] to the classified areas, only three continuous photographing occur by sequentially focusing on a seventh area, a fourth area, and a first area. The multi-focus photographing is not performed on the second, third, fifth, sixth, eighth, and ninth areas to which the order value ‘0’ is assigned. Accordingly, in the example described above, the photographing screen is divided and classified into nine areas, but only three images are generated as the multi-focus image 130A.

Thereafter, the photographing device 100A communicates with the discriminating device 200A and transmits the stored multi-focus image 130A to the discriminating device 200A. In this case, the photographing device 100A transmits the time information and the MAC address 110A that are previously obtained to the discriminating device 200A together in order to generate the random number information in the discriminating device 200A.

As an example, in this case, the photographing device 100A may pack each of the images according to a photographing order thereof and transmit the packed image to the discriminating device 200A so that the discriminating device 200A may check the photographing order of each of the images included in the multi-focus image.

Alternatively, as an example, the photographing device 100A may transmit the multi-focus image together with information indicating the photographing order of each of the images to the discriminating device 200A so that the discriminating device 200A may check the photographing order of each of the images included in the multi-focus image.

The discriminating device 200A receives the transmitted multi-focus image 220A, and checks the time information and the MAC address 110A transmitted together with the multi-focus image 220A. In addition, the discriminating device 200A generates random number information 210A for discriminating the multi-focus image 220A based on the time information and the MAC address 110A that are checked. In this case, the discriminating device 200A may generate the random number information 210A by inputting the time information and the MAC address 110A that are checked as input factors to the same random number generation algorithm as that previously used by the photographing device 100A. Since the same input factor is input to the same random number generation algorithm, the number information 210A, which is a result value thereof, is also output as the same value as the random number information 120A of the photographing device 100A.

In addition, the discriminating device 200A discriminates the type of the transmitted multi-focus image 220A by referring to the screen division value and the order value included in the random number information 210A.

Specifically, the discriminating device 200A checks whether the focused area of the multi-focus image matches the screen division value by referring to the screen division value among the random number information 210A. If the screen division value and the focused area of the multi-focus image do not match each other (for example, if the area that is not divided according to the screen division value is focused, or two or more areas divided according to the screen division value are focused at the same time), this means that the multi-focus photographing is not performed according to a predetermined method. Therefore, the discriminating device 200A may discriminate the type of the multi-focus image 220A as a two-dimensional subject image, or a forged or falsified image.

In addition, the discriminating device 200A checks whether the focused order of the multi-focus image matches the order value by referring to the order value among the random number information 210A. If the order value and the focused order of the multi-focus image do not match each other (for example, in the order value, the third area among the classified areas is focused and photographed first, but in an actual multi-focus image, the first area is focused first), this also means that the multi-focus photographing is not performed according to a predetermined method. Therefore, the discriminating device 200A may discriminate the type of the multi-focus image 220A as the two-dimensional subject image, or the forged or falsified image.

On the other hand, if the focused area of the multi-focus image matches the screen division value and the order value of the random number information 210A, respectively, the discriminating device 200A may recognize that the multi-focus photographing is performed according to a predetermined method, and may discriminate the type of the multi-focus image 220A as the three-dimensional subject image or the real image.

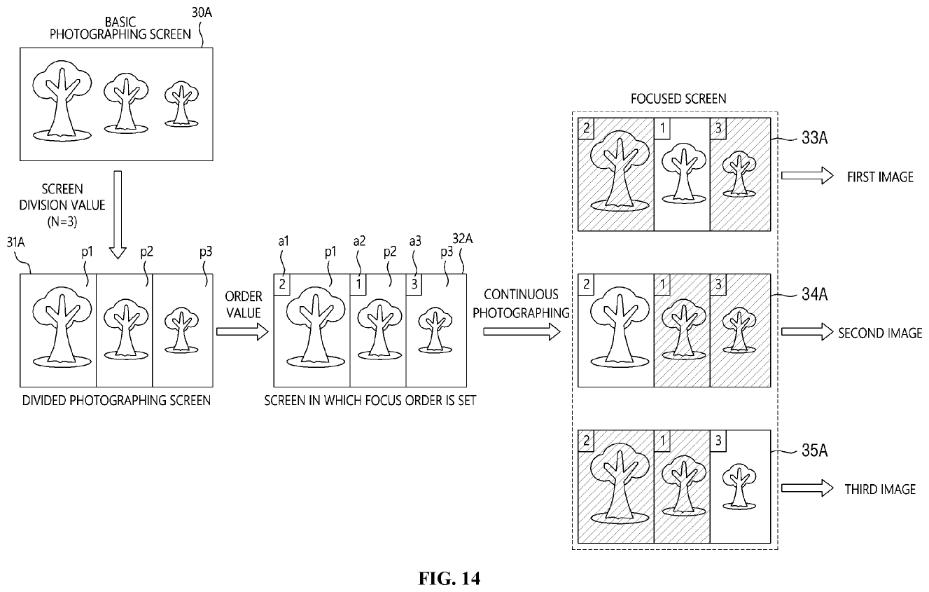

FIG. 14 is a diagram for specifically describing the multi-focus image mentioned in FIG. 13 and a photographing method thereof. In an exemplary embodiment of FIG. 14, multi-focus photographing when the screen division value is 3 and the order value is [2, 1, 3] is exemplarily described.

Referring to FIG. 14, first, a basic photographing screen 30A is illustrated. This is, for example, a display screen of the photographing device 100A, indicating an initial photographing screen before starting the multi-focus photographing. Three trees are displayed as subjects on the basic photographing screen 30A.

Thereafter, the photographing device 100A obtains random number information and extracts a screen division value therefrom. In this case, the screen division value is exemplified as 3 (N=3). In addition, the photographing device 100A divides the basic photographing screen 30A into a plurality of areas according to the screen division value. In a middle portion of FIG. 14, a photographing screen 31A in which an entire screen is divided into a plurality of areas p1, p2, and p3 is illustrated.

In addition, the photographing device 100A sets a focus order for each of the classified areas p1, p2, and p3 according to an order value of the random number information. A screen 32A in which the focus orders a1, a2, and a3 are set for each of the classified areas p1, p2, and p3 is illustrated in a central portion of FIG. 14. In the exemplary embodiment of FIG. 14, it is exemplified that the focus order is set to ‘2’ for a first area p1, ‘1’ for a second area p2, and ‘3’ for a third area p3 among the classified areas.

Then, the photographing device 100A performs continuous photographing according to the set focus orders a1, a2, and a3 for each of the classified areas p1, p2, and p3. Specifically, the photographing device 110A first focuses on the second area p2 having a focus order of ‘1’ to photograph three trees, which are subjects. In FIG. 14, a non-focused area is indicated by hatching in order to distinguish the non-focused area from the focused area. A result of performing the first multi-focus photographing in this way is generated as a first image 33A. Then, the photographing device 110A subsequently focuses on the first area p1 having the focus order of ‘2’ to repeatedly photograph the three trees, which are the same subject. As described above, a result of the second multi-focus photographing is generated as a second image 34A. Then, the photographing device 110A finally focuses on the third area p3 having the focus order of ‘3’ to repeatedly photograph the three trees, which are the same subject. Similarly, a result of the third multi-focus photographing is generated as a third image 35A.

When all multi-focus photographing according to the order values is completed, the photographing device 100A packs and stores the generated images (first to third images) as a multi-focus image.

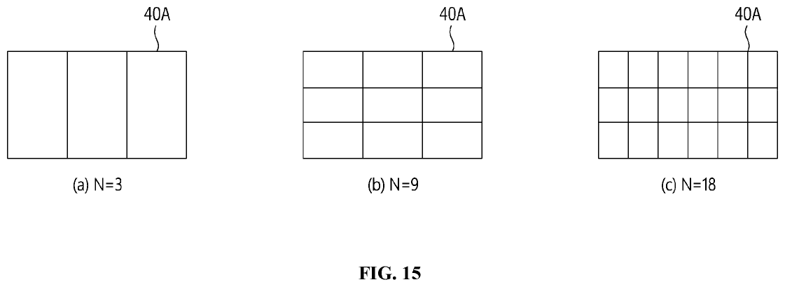

FIG. 15 is a diagram for specifically describing examples of screen classification according to various screen division values. Hereinafter, a description will be provided with reference to the drawings.

(a) of FIG. 15 illustrates a case in which the screen division value is 3 (N=3), and a case in which the entire photographing screen is classified into three areas as in the example of FIG. 14. Here, a case of vertically dividing the entire screen is illustrated, but the present disclosure is not limited thereto, and the entire screen may also be horizontally divided.

(b) of FIG. 15 illustrates a case in which the screen division value is 9 (N=9), and a case in which the entire photographing screen is classified into nine areas. As the most basic method, the entire screen may be equally divided into the nine areas as shown, but the present disclosure is not limited thereto. For example, it is also possible to divide some areas to have a relatively larger area.

(c) of FIG. 15 illustrates a case in which the screen division value is 18 (N=18), and a case in which the entire photographing screen is classified into eighteen areas. As in (b) of FIG. 15, an example of equal division is illustrated here, but the present disclosure is not limited thereto, and it is also possible to divide some areas to have a relatively larger area or smaller area.

Meanwhile, FIG. 15 exemplarily describes various cases of screen division, and it is apparent to those skilled in the art that various screen division methods (for example, when the screen division value is 3000, or when the screen division area is a triangle) not described herein may be modified and applied.

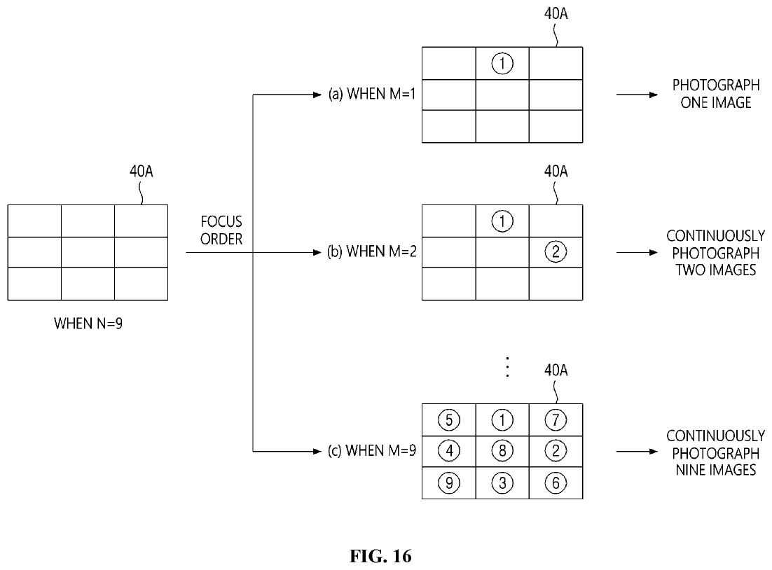

FIG. 16 is a diagram for specifically describing examples of setting a photographing order according to various order values. In an exemplary embodiment of FIG. 16, a case in which the screen division value is 9 (N=9) is exemplified and described for specificity of description.

(a) of FIG. 16 illustrates a case in which multi-focus photographing is performed for only one image. Since this is to photograph a single image, it is somewhat different from the meaning of multi-focus, but for unity of terminology, the term multi-focus is also used in this case. Since it is a case of photographing one image, an order value of ‘1’ is set for only one of the nine classified areas. Here, it is exemplified that the order value of ‘1’ is set in a second area. When the multi-focus photographing is started, the photographing device 100A checks the areas classified according to the screen division value and focuses the second area among the areas to photograph one image. As an example, in this case, the total order value extracted from the random number information 120A may be a vector value such as [0, 1, 0, 0, 0, 0, 0, 0, 0].

(b) of FIG. 16 illustrates a case in which multi-focus photographing is performed for two images. Since it is a case of photographing the two images, order values of ‘1’ and ‘2’ are set for two of the nine classified areas. Here, it is exemplified that the order value of ‘1’ is set in the second area and the order value of ‘2’ is set in a sixth area. When the multi-focus photographing is started, the photographing device 100A checks the areas classified according to the screen division value, first focuses on the second area to photograph one image, and then focuses on the sixth area to photograph one image again. As an example, in this case, the total order value extracted from the random number information 120A may be a vector value such as [0, 1, 0, 0, 0, 2, 0, 0, 0].

(c) of FIG. 16 illustrates a case in which multi-focus photographing is performed for nine images. Since this is a case of photographing nine images, an order value of ‘1’ to ‘9’ is set for each of the nine classified areas. When the multi-focus photographing is started, the photographing device 100A checks the areas classified according to the screen division value, and sequentially focuses on the nine areas according to the order values illustrated in (c) of FIG. 16 to successively photograph the nine images. As an example, in this case, the total order value extracted from the random number information 120A may be a vector value such as [5, 1, 7, 4, 8, 2, 9, 3, 6].

As described above, when the order of multi-focus photographing is specified for a plurality of areas after the photographing screen is divided into the plurality of areas, security from external hacking or malicious forgery or falsification may be greatly improved.

For example, when the screen division value is 9 and the multi-focus photographing is performed for three images, the number of cases of multi-focus images that may be generated therefrom becomes 9 to the power of 3. Therefore, even if the multi-focus image is maliciously manipulated and submitted from the outside, a probability that the multi-focus image matches a correct screen division value and order value (that is, a probability of discriminating the multi-focus image as a real image) is as low as 0.13%. Therefore, it is possible to filter out forged and falsified images with a very high probability. Such security increases as the screen division value and the number of images to be photographed increase. For example, if the screen division value is 18 and the number of images for which the multi-focus photographing is performed is 5, a probability of erroneously discriminating the manipulated image as a real image is extremely low to 1/1,889,569, which is 1 divided by 18 to the power of 5.

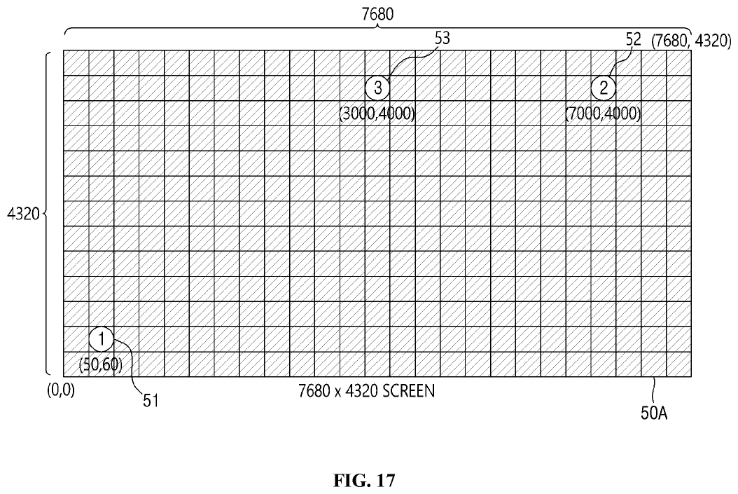

FIG. 17 is a diagram for describing an exemplary embodiment in which the method of photographing an image according to the present disclosure is applied in units of pixels.

While the above exemplary embodiments have illustrated that multi-focus photographing is performed for the areas separately classified according to the screen division values, in the exemplary embodiment of FIG. 17, the multi-focus photographing is performed for pixels of a photographing screen. Accordingly, in the exemplary embodiment of FIG. 17, since the subject may be focused based on each pixel already determined in hardware, a screen division value for screen classification may not be separately required (because it may be seen that the photographing screen is already classified for each pixel).

In FIG. 17, the photographing device 100A extracts order values from the random number information 120A, and sequentially focuses each pixel according to the extracted order values to perform multi-focus photographing of several images for the same subject.

For example, as in the illustrated example, assuming that the number of pixels of the photographing screen is 7680×4320, and the extracted order values are [0, 0, . . . , 3, . . . , 0, 0, . . . , 2, . . . , 0, 0, . . . , 1, , . . . , 0, 0]. In this case, the order value of ‘3’ matches a pixel at a coordinate (3000, 4000), the order value of ‘2’ matches a pixel at a coordinate (7000, 4000), and the order value of ‘1’ matches a pixel at a coordinate (50, 60), respectively.

By referring to the extracted order values, the photographing device 100A focuses on the pixel at the coordinate (50, 60) in which the order value of ‘1’ is set to photograph a first image, subsequently focuses on the pixel at the coordinate (7000, 4000) in which the order value ‘2’ is set to photograph a second image, and finally focuses on the pixel at the coordinate (3000, 4000) in which the order value of ‘3’ is set to photograph a third image. The photographed images (first to third images) are packed as multi-focus images and transmitted to the discriminating device 200A.

The discriminating device 200A generates the random number information 210A in the same manner as in the previous exemplary embodiments, and extracts the order values therefrom. In addition, the discriminating device 200A verifies a multi-focus image of whether each of the pixels is sequentially focused and photographed according to the extracted order values, and discriminates whether the multi-focus image is a three-dimensional subject image (real image) or a two-dimensional subject image (forged, falsified, or processed image) according to a result thereof.

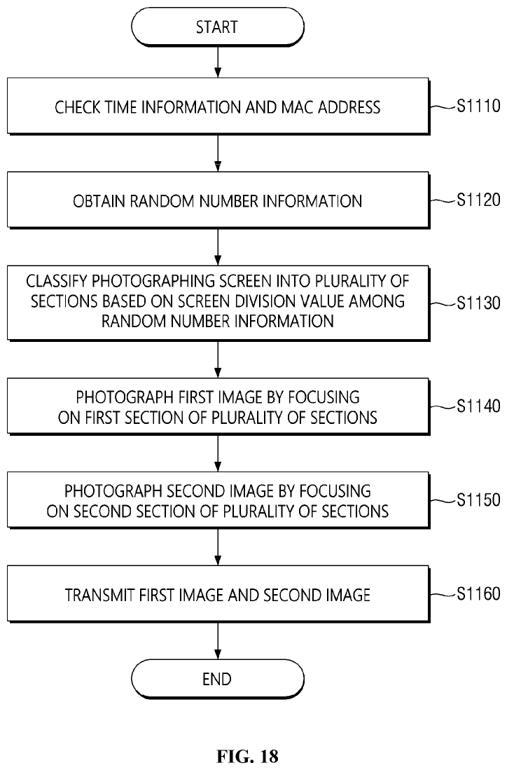

FIGS. 18 to 20 illustrate flowcharts of various exemplary embodiments according to the present disclosure. In order to avoid the complexity of the description, in the following description, ‘each area classified according to a screen division value’ will be briefly referred to as a ‘section’. In addition, in order to avoid duplication of description, repeated descriptions of the same content as that of described above will be omitted as much as possible.

FIG. 18 is a flowchart illustrating a method of photographing an image according to an exemplary embodiment of the present disclosure. The exemplary embodiment of

FIG. 18 illustrates a method of photographing a multi-focus image performed by the photographing device 100A illustrated in FIG. 12. Accordingly, in the case in which the performing subject of each step is omitted in the exemplary embodiment of FIG. 18, it is assumed that the performing subject is the photographing device 100A.

In step S1110, the photographing device 100A checks time information and an MAC address. In this case, the time information may be time information of a clock built into the photographing device 100A or time information obtained through a network connected to the photographing device 100A. The MAC address may be an MAC address of the photographing device 100A.

In step S1120, the photographing device 100A obtains random number information based on the time information and the MAC address that are checked. As an example, the photographing device 100A may obtain the random number information by inputting the time information and the MAC address as input information to a predetermined random number generation algorithm.

In this case, the obtained random number information may include a screen division value and an order value for multi-focus photographing.

In step S1130, the photographing device 100A classifies the photographing screen illuminating the subject into a plurality of sections based on the screen division value among the random number information.

Thereafter, the photographing device 100A sets a focus order of the plurality of sections previously classified based on the order value among the random number information, and focuses on each section according to the set focus order to perform continuous photographing.

In step S1140, the photographing device 100A focuses on a first section having a faster focus order among the plurality of sections to photograph a first image.

In step S1150, the photographing device 100A focuses on a second section having a later focus order among the plurality of sections to photograph a second image.

In step S1160, the photographing device 100A packs and stores the photographed first and second images as a multi-focus image. In this case, the photographing device 100A may pack the time information and the MAC address referenced to obtain the random number information together. In addition, when the photographing device 100A is connected to the discriminating device 200A through a network, the photographing device 100A transmits the previously stored multi-focus image to the discriminating device 200A.

Thereafter, the discriminating device 200A verifies whether each section is focused according to the screen division value and the order value with respect to the transmitted multi-focus image, and discriminates the type thereof.

Meanwhile, in the exemplary embodiment of FIG. 18, a case in which the multi-focusing photographing is performed for the plurality of sections has been described, but the scope of the present disclosure is not limited thereto. For example, it is also possible to focus on only one section (first section) among the plurality of sections to generate only one image (first image) as the multi-focus image. In this case, the discriminating device 200A discriminates the type of the multi-focus image by only checking whether the focused section of the first image is a photographing section designated in the order value.

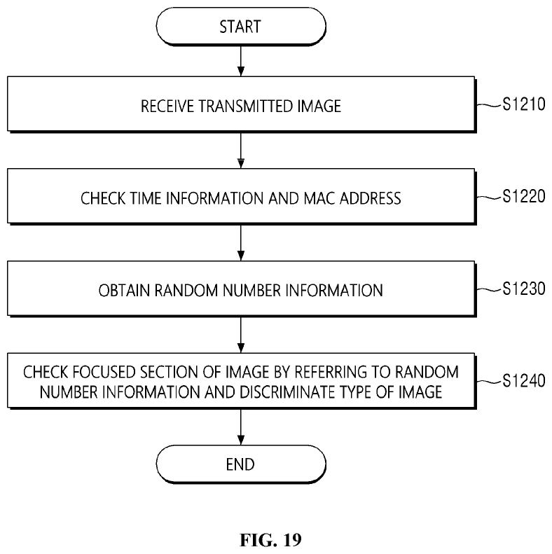

FIG. 19 is a flowchart illustrating a method of discriminating an image according to an exemplary embodiment of the present disclosure. The exemplary embodiment of FIG. 19 illustrates a method of discriminating a multi-focus image performed by the discriminating device 200A illustrated in FIG. 12. Accordingly, in the case in which the performing subject of each step is omitted in the exemplary embodiment of FIG. 19, it is assumed that the performing subject is the discriminating device 200A.

In step S1210, the discriminating device 200A receives the multi-focus image transmitted by the photographing device 100A.

In step S1220, the discriminating device 200A checks the time information and the MAC address transmitted together from the photographing device 100A.

In step S1230, the discriminating device 200A obtains random number information based on the time information and the MAC address that are previously checked. As an example, the discriminating device 200A may obtain the random number information by inputting the time information and the MAC address that are checked as input information to the same random number generation algorithm as that of the photographing device 100A. The obtained random number information may include a screen division value and an order value used for multi-focus photographing.

In step S1240, the discriminating device 200A verifies whether the focused sections of the multi-focus image match the screen division value and the order value by referring to the screen division value and the order value of the random number information, and discriminates the type of the multi-focus image as a three-dimensional subject image (real image) or a two-dimensional subject image (forged, falsified, or processed image) according to the verification result.

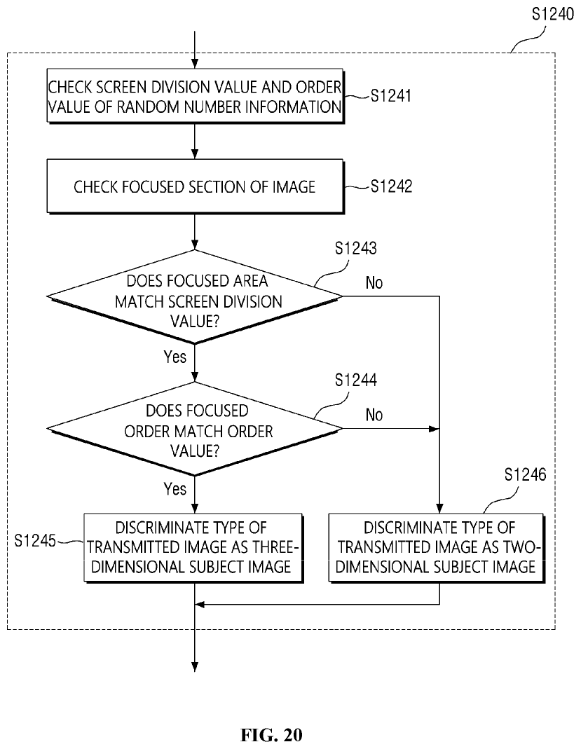

This will be described in more detail with reference to FIG. 20. FIG. 20 is a flowchart illustrating an exemplary embodiment in which the step S1240 of discriminating a type of an image of FIG. 19 is described in more detail. Hereinafter, a description will be provided with reference to the drawings.

In step S1241, the discriminating device 200A checks a screen division value and an order value among the random number information.

In step S1242, the discriminating device 200A checks a focused section of each of the images included in the multi-focus image. For example, when first to third images are included in the multi-focus image, the discriminating device 200A checks a focused section of the first image, a focused section of the second image, and a focused section of the third image, respectively.

In step S1243, the discriminating device 200A checks whether the focused area of each image matches the screen division value. If the focused area of each image does not match the screen division value (for example, if two or more of the sections according to the screen division value are simultaneously focused within one image, etc.), the present exemplary embodiment proceeds to step S1246. Conversely, if the focused area of each image matches the screen division value (for example, if the focused area of each image fits in the section according to the screen division value), the present exemplary embodiment proceeds to step S1244.

In step S1244, the discriminating device 200A checks whether the focused order of each section matches the order value. If the focused order of each section does not match the order value (for example, if a first section has the order value of ‘3’, but is actually focused and photographed first, etc.), the present exemplary embodiment proceeds to step S1246. Conversely, if the focused order of each section matches the order value (for example, each section is sequentially focused and photographed according to the order value set for each section), the present exemplary embodiment proceeds to step S1245.

In step S1245, since it is checked that the transmitted multi-focus image is multi-focus photographed according to the screen division value and the order value, the discriminating device 200A discriminates the type of the multi-focus image as a three-dimensional subject image (or a real image).

On the other hand, if the process proceeds from steps S1243 and S1244 to step S1246, the transmitted multi-focus image is not multi-focus photographed according to the screen division value and the order value. Therefore, in step S1246, the discriminating device 200A discriminates the type of the multi-focus image as a two-dimensional subject image (or a forged, falsified, or processed image).

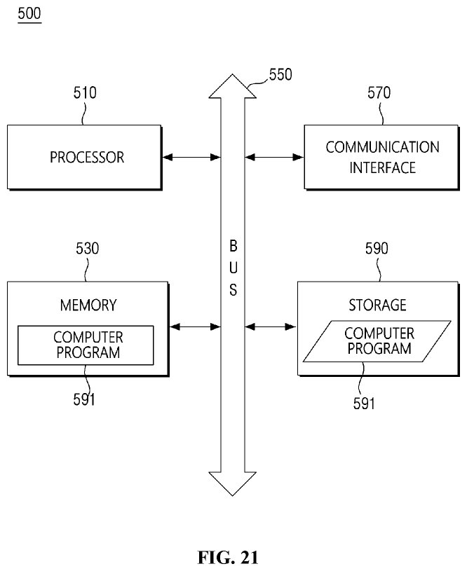

Hereinafter, an exemplary computing device 500 in which the methods described in various exemplary embodiments of the present disclosure are implemented will be described with reference to FIG. 21. For example, the user terminal 100 or the key management server 200 of FIG. 1, and the photographing device 100A or the discriminating device 200A of FIG. 12 may be implemented as the computing device 500 of FIG. 21.

FIG. 21 is an exemplary hardware configuration diagram illustrating the computing device 500.

As illustrated in FIG. 21, the computing device 500 may include one or more processors 510, a bus 550, a communication interface 570, a memory 530 for loading a computer program 591 executed by the processor 510, and a storage 590 for storing the computer program 591. However, only the components related to the exemplary embodiments of the present disclosure are illustrated in FIG. 21. Accordingly, those skilled in the art to which the present disclosure pertains may see that other general-purpose components other than the components illustrated in FIG. 21 may be further included.

The processor 510 controls the overall operation of each component of the computing device 500. The processor 510 may be configured to include at least one of a central processing unit (CPU), a microprocessor unit (MPU), a micro controller unit (MCU), a graphic processing unit (GPU), or any type of processor well known in the art. In addition, the processor 510 may perform a calculation on at least one application or program for executing the methods/operations according to various exemplary embodiments of the present disclosure. The computing device 500 may include one or more processors.

The memory 530 stores various data, commands, and/or information. The memory 530 may load one or more programs 591 from the storage 590 to execute the methods/operations according to various exemplary embodiments of the present disclosure. An example of the memory 530 may be a RAM, but is not limited thereto.

The bus 550 provides a communication function between the components of the computing device 500. The bus 550 may be implemented as various types of buses, such as an address bus, a data bus, and a control bus.

The communication interface 570 supports wired/wireless Internet communication of the computing device 500. The communication interface 570 may also support various communication methods other than Internet communication. To this end, the communication interface 570 may be configured to include a communication module well known in the art.

The storage 590 may non-temporarily store one or more computer programs 591. The storage 590 may be configured to include a non-volatile memory such as a read only memory (ROM), an erasable programmable ROM (EPROM), an electrically erasable programmable ROM (EEPROM), a flash memory, or the like, a hard disk, a removable disk, or any type of computer-readable recording medium well known in the art.

The computer program 591 may include one or more instructions in which the methods/operations according to various exemplary embodiments of the present disclosure are implemented.

For example, the computer program 591 may include instructions for executing an operation of obtaining target data, an operation of obtaining a plurality of partial signatures associated with the target data, an operation of generating a signature of the target data based on the plurality of partial signatures, and an operation of transmitting the target data and the signature to an external device. In this case, the plurality of partial signatures may be respectively generated based on different private keys among the plurality of private keys, a first private key of the plurality of private keys may be stored in a storage of a first device, a second private key of the plurality of private keys may be stored in a storage of a second device, and the first device and the second device may be physically separated from each other.

Alternatively, the computer program 591 may include instructions for executing an operation of extracting a plurality of public keys from a plurality of key management information in response to a verification key provision request from a service requesting device, an operation of generating a verification key based on the plurality of public keys, and an operation of transmitting the verification key to the service requesting device. In this case, the plurality of key management information may correspond to a plurality of terminals or a plurality of accounts, respectively, the plurality of public keys may correspond to a plurality of private keys distributed and stored in the plurality of terminals or the plurality of accounts, respectively, and the verification key may be used to verify the signature generated based on the plurality of private keys.

When the computer program 591 is loaded into the memory 530, the processor 510 may perform the methods/operations according to various exemplary embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as interne and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. An original certification method performed by a computing device, the original certification method comprising:
generating a plurality of private keys comprising a first private key and a second private key and storing the first private key in a first device and a second private key in a second device which is physically separated from the first device;
obtaining target data;
obtaining a plurality of partial signatures associated with the target data, the plurality of partial signatures respectively generated based on different private keys among the plurality of private keys, the plurality of partial signatures comprising a first partial signature and a second partial signature;
generating a signature of the target data based on the plurality of partial signatures; and
transmitting the target data and the signature to an external device.

2. The original certification method of claim 1, wherein the first device is a user terminal; and
the second device is another terminal registered with a key management server.

3. The original certification method of claim 1, wherein the first device is a user terminal; and
the second device is a service server accessible through an account registered with a key management server.

4. The original certification method of claim 1, wherein the obtaining of the target data includes generating hash data for at least a portion of the target data.

5. The original certification method of claim 4, wherein the first partial signature is a signature value generated based on the first private key and the hash data; and
a second partial signature is a signature value generated based on the second private key and the hash data.

6. The original certification method of claim 5, wherein the second partial signature is generated in the second device; and
the obtaining of the plurality of partial signatures includes receiving the second partial signature.

7. The original certification method of claim 1, wherein, in the generating of the signature of the target data, the signature is generated based on a combination of the plurality of partial signatures.

8. The original certification method of claim 1, wherein the generating of the plurality of private keys further comprises generating a plurality of public keys corresponding to each of the plurality of private keys.

9. The original certification method of claim 8, wherein the plurality of private keys are distributed and stored in a plurality of devices including the first device and the second device; and
the plurality of public keys are transmitted to a key management server.

10. The original certification method of claim 9, further comprising generating a verification key based on the plurality of public keys,
wherein the external device verifies the target data or the signature using the verification key.

11. The original certification method of claim 10, wherein the verification key is provided from the key management server to the external device in response to a request from the external device.

12. The original certification method of claim 1, wherein the obtaining of the target data includes generating an image by photographing a subject by a photographing method based on a real subject discrimination algorithm.

13. The original certification method of claim 12, wherein the generating of the image includes:
obtaining a screen division value;
classifying a photographing screen into a plurality of sections based on the screen division value;
photographing a first image by focusing on a first section among the plurality of sections;
photographing a second image by focusing on a second section among the plurality of sections; and
storing the first image and the second image as the image.

14. An original certification method performed by a computing device, the original certification method comprising:
extracting a plurality of public keys from a plurality of key management information in which the plurality of public keys are stored together with terminal information or account information corresponding thereto, in response to a verification key provision request from a service requesting device;
generating a verification key based on the plurality of public keys; and
transmitting the verification key to the service requesting device,
wherein the plurality of key management information correspond to a plurality of terminals or a plurality of accounts, respectively;
the plurality of public keys correspond to a plurality of private keys distributed and stored in the plurality of terminals or the plurality of accounts, respectively; and
the verification key is used to verify a signature generated based on the plurality of private keys.

15. The original certification method of claim 14, further comprising updating the plurality of key management information in response to a request from a user terminal.

16. The original certification method of claim 14, further comprising discriminating whether a target image is an image obtained by photographing a real subject in response to a real subject verification request from the service requesting device.

17. The original certification method of claim 16, wherein the target image includes a first image and a second image which are images obtained by photographing the same subject; and
the discriminating includes:
obtaining a screen division value related to the image;
checking focused sections of the first image and the second image with reference to the screen division value; and
discriminating whether the image is an image obtained by photographing a real subject based on a result of checking the focused sections.

18. A computing device comprising:
a processor; and
a memory into which a computer program is loaded,
wherein the computer program includes:
an instruction for generating a plurality of private keys comprising a first private key and a second private key and storing the first private key in a first device and a second private key in a second device which is physically separated from the first device;
an instruction for obtaining target data;
an instruction for obtaining a plurality of partial signatures associated with the target data based on different private keys among the plurality of private keys;
an instruction for generating a signature of the target data based on the plurality of partial signatures; and
an instruction for transmitting the target data and the signature to an external device.

19. A computing device of claim 18, wherein the computer program further includes an instruction for generating a plurality of public keys corresponding to each of the plurality of private keys.

20. A computing device of claim 19, wherein the plurality of private keys are distributed and stored in a plurality of devices including the first device and the second device; and
the plurality of public keys are transmitted to a key management server.
